(19) United States
(12) Patent Application Publication
(10) Pub. No.: US 2020/0072026 A1
(43) Pub. Date: Mar. 5, 2020

(54) MODELING EVOLUTION OF SETTLED BED OF HEAVY PARTICLES IN FLUIDS

(71) Applicant: Halliburton Energy Services, Inc., Houston, TX (US)

(72) Inventors: Baidurja RAY, Houston, TX (US); Dinesh Ananda SHETTY, Sugar Land, TX (US)

(21) Appl. No.: 16/344,335

(22) PCT Filed: Jan. 10, 2017
(86) PCT No.: PCT/US2017/012807

§ 371 Date: Apr. 23, 2019

(51) Int. Cl. E21B 41/00; G06F 17/50; E21B 43/267

(52) U.S. Cl. CPC E21B 41/0092; E21B 43/267; G06F 17/5009

(57) ABSTRACT

A method for performing a wellbore operation that includes generating a multiphase fluid flow model defining at least two layers comprising a first layer including a proppant-fluid mixture and a second layer including a bed of settled proppant, simulating a behavior of the bed of settled proppant in a flow path using the multiphase fluid flow model and thereby obtaining a simulation result, and performing the wellbore operation based on the simulation result.

### BACKGROUND

To produce hydrocarbons (e.g., oil, gas, etc.) from a subterranean formation, wellbores may be drilled that penetrate hydrocarbon-containing portions of the subterranean formation. The portion of the subterranean formation from which hydrocarbons may be produced is commonly referred to as a “production zone.” In some instances, a given subterranean formation may have multiple production zones at various locations along the wellbore.

Generally, after a wellbore has been drilled to a desired depth, completion operations are performed, which may include inserting a liner or casing into the wellbore and, at times, cementing the casing or liner into place. In other applications, the wellbore is left uncased or “open hole.” Once the wellbore is completed as desired (lined, cased, open hole, or any other known completion), a stimulation operation may be performed to enhance hydrocarbon production from the wellbore. Examples of common stimulation operations include hydraulic fracturing, acidizing, fracture acidizing, and hydrajetting. Hydraulic fracturing, for instance, entails injecting a fluid under pressure into a subterranean formation to generate a network of cracks and fractures, and simultaneously depositing a proppant (e.g., sand, ceramics) in the resulting fractures. The proppant prevents the fractures from closing and enhances the conductivity of the formation, thereby increasing the production of oil and gas from the formation.

Multiphase fluid flow models can be used to simulate the flow of the fluid in the wellbore and within the fracture network during hydraulic fracturing operations. Multiphase fluid flow models can also be used to simulate the transportation of the proppant contained in the fluid.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1A schematically illustrates a schematic view of a fracture having a proppant bed formed therein.

FIG. 1B schematically illustrates the proppant bed of FIG. 1A having a lateral surface that defines angles θ1 and θ2.

FIGS. 2A and 2B graphically compare the equilibrium bed heights obtained experimentally and obtained using multiphase fluid flow models.

FIG. 2C graphically compares the equilibrium bed heights obtained experimentally and from example multiphase fluid flow models against a hypothetical “y=x” line that indicates a perfect match.

FIG. 3 is a block diagram of a computer system that may be used to construct one or more multiphase fluid flow models and simulate a well system.

FIG. 4 is a schematic diagram of a stimulation system for performing hydraulic fracturing operations based on modeling results from the multiphase fluid flow models.

FIG. 5 shows a well system employing the principles of the present disclosure.

### DETAILED DESCRIPTION

The present disclosure is directed to methods of modelling flow of fluids laden with particles in a flow path, such as a wellbore, a subterranean formation fracture, and the like. Modelling the flow of such fluids helps characterize and otherwise describe the behavior of a bed of heavy particles contained in the fluid due to settling, resuspension, and interaction between the bed and the fluid. In an example, the heavy particles may be or include proppant used in wellbore hydraulic fracturing operations. However, the embodiments disclosed herein are equally applicable for modelling flows of fluids containing heavy particles other than proppant.

The presently described multiphase fluid flow models may simulate (e.g., model) the behavior of the proppant bed including the time-dependent build-up of a proppant bed, the movement (horizontal, vertical, radial, axial, a combination thereof, and the like) of the proppant bed, the flow of fluid through the bed of settled proppant, the transport of proppant in the proppant slurry, the transport of the proppant from the proppant bed to the proppant slurry, the transport of the proppant from the proppant slurry to the proppant bed, a combination thereof, and the like. For example, the multiphase fluid flow models may simulate the development and behavior of the settled proppant bed during the injection stage of a hydraulic fracturing operation during which a proppant slurry is injected into the formation. In addition, the multiphase fluid flow models may also simulate the flow of hydrocarbons or fluids through the settled proppant bed during the flowback stage of the hydraulic fracturing operation during which the hydrocarbons or fluids are produced to the surface. The multiphase fluid flow models may also simulate the pressure response due to the development and evolution of the proppant bed, and, in turn, may better estimate the hydrocarbon production rate and volume from the wellbore.

As used herein, the term “proppant,” or variations thereof, refers to a mixture of one or more particulate solids suitable for use in subterranean operations. Suitable materials for these particulates include, but are not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The mean particulate size generally may range from about 2 mesh (1 cm) to about 400 mesh (0.04 mm) or less on the U.S. Sieve Series; however, in certain circumstances, other sizes or mixtures of sizes may be desired and will be entirely suitable for practice of the embodiments of the present disclosure. In particular embodiments, preferred mean particulates size distribution ranges are one or more of 6/12 mesh (3.4 mm/1.7 mm), 8/16 mesh (2.4 mm/1.2 mm), 12/20 mesh (1.7 mm/0.84 mm), 16/30 mesh (1.2 mm/0.56 mm), 20/40 mesh (0.84 mm/0.4 mm), 30/50 mesh (0.60 mm/0.30 mm), 40/60 mesh (0.4 mm/0.25 mm), 40/70 mesh (0.40 mm/0.21 mm), or 50/70 mesh (0.30 mm/0.21 mm).

It should be understood that the term “particulate,” as used in this disclosure, includes all known shapes of materials, including substantially spherical materials, fibrous materials, polygonal materials (such as cubic materials), and combinations thereof. Moreover, fibrous materials, that may or may not be used to bear the pressure of a closed fracture, may be included in certain embodiments disclosed herein. In certain embodiments, the particulates may be present in an amount of from about 0.01 pounds per gallon (“ppg”) to about 30 ppg by volume of the treatment fluid, including subsets therebetween (e.g., about 0.01 ppg to about 0.1 ppg, about 0.01 ppg to about 0.5 ppg, about 0.01 ppg to about 1 ppg, about 0.1 to about 1 ppg, about 1 ppg to about 10 ppg, about 1 ppg to about 30 ppg, about 5 ppg to about 20 ppg, or about 10 ppg to about 30 ppg).

The embodiments described herein are directed primarily to simulating fluid flow of a single fluid containing one proppant type. However, it should be noted that embodiments disclosed are equally applicable to analyzing fluid flows of multiple fluids containing multiple proppant types, without departing from the scope of the disclosure.

For purposes of discussion, embodiments are described herein with reference to a flow of proppant slurry in a single dimension through a single fracture and the development and evolution of the proppant bed in the single fracture. However, it should be noted that embodiments disclosed are equally applicable to a multi-dimensional flow (e.g., at least two-dimensional), without departing from the scope of the disclosure. Further, embodiments disclosed are equally applicable for analyzing single- or multi-dimensional fluid flows in other flow paths, such as a wellbore, a fracture network including a plurality of fractures, at a wellbore junction, in an annulus, within reservoir rock matrix, in a downhole tool, and other portions of a well system where the proppant slurry can flow.

Embodiments disclosed herein also account for proppant bridging in the hydraulic fracturing process. For example, the methods of the present disclosure may comprise a proppant transport model that may account for both geometric bridging and proppant bridging due to the concentration effect. Moreover, the methods and systems may provide a more flexible and versatile proppant transport and bridging model suitable for all ranges of proppant concentrations.

As used herein, “proppant bridging,” or variations thereof, refers to the plugging off of pore spaces or fluid paths by proppant in a rock formation or the restricting of flow by proppant in a wellbore or annulus. As used herein, “geometric bridging,” or variations thereof, refers to the plugging off of pore spaces or fluid paths by proppant due to geometric restrictions in one or more portions of a well system. In certain embodiments, proppant bridging may occur due to the concentration effect. As used herein, the “concentration effect,” or variations thereof, refers to the bridging of proppant due to the concentration of proppant in a fluid. For example, bridging due to the concentration effect occurs due to an increase in proppant concentration up to a maximum possible concentration (referred to as “maximum proppant packing”).

As discussed below, a two-layer representation of the flow of fluids and proppants inside a fracture is developed for simulating the evolution of settled proppant bed in different fluids. The two-layer representation captures or otherwise simulates the essential physics of settling, resuspension and bed equilibrium in a computationally efficient way and utilizes the assumption of a fully developed flow to efficiently capture the flow above and through the bed. The representation can be used in a fully coupled implicit solver (e.g., simulator) to solve for the proppant bed along with the other fluid and rock variables, rather than a less accurate post-process calculation as is done in some existing prior art models. Unlike the prior art fluid flow models, the multiphase fluid flow models disclosed herein avoid the expensive computation of separate momentum equations for each proppant phase. By using appropriate models for settling, resuspension and proppant bed velocities, embodiments disclosed allow for efficient simulation of any fluid-proppant combination.

As used herein, the phrase “proppant slurry,” or variations thereof, refers to a proppant-fluid mixture that includes a granular solid, such as sand, with desired fluid additives. The proppant slurry may be any mixture capable of suspending and transporting proppant in desired concentrations. For example, the proppant slurry may contain above about 25 pounds of proppant per gallon of proppant slurry. In other examples, the proppant slurry may contain up to 27 pounds of granular solid per gallon of fluid. In certain examples, the fluid additives in the proppant slurry may include gelling agents, crosslinking agents, viscosity modifiers, acids (e.g., acetic acid, hydrochloric acid, citric acid), salts (e.g., sodium chloride, borate salts), fluid loss control additives, clay stabilizers, surfactants, oxygen scavengers, alcohols, breakers, bactericides, and non-emulsifying agents, thickeners, etc.

It should be noted that the proppant slurry is injected into the formation via a fracturing fluid, which is a mixture of proppant slurry and a clean fluid in a desired proportion. The clean fluid may refer to a fluid that does not have significant amounts of proppant or other solid materials suspended therein. Clean fluids may include most brines and may also include fresh water. The brines may sometimes contain viscosifying agents or friction reducers. The clean fluid may also comprise an energized fluid such as foamed or comingled brines with carbon dioxide or nitrogen, acid mixtures or oil-based fluids and emulsion fluids.

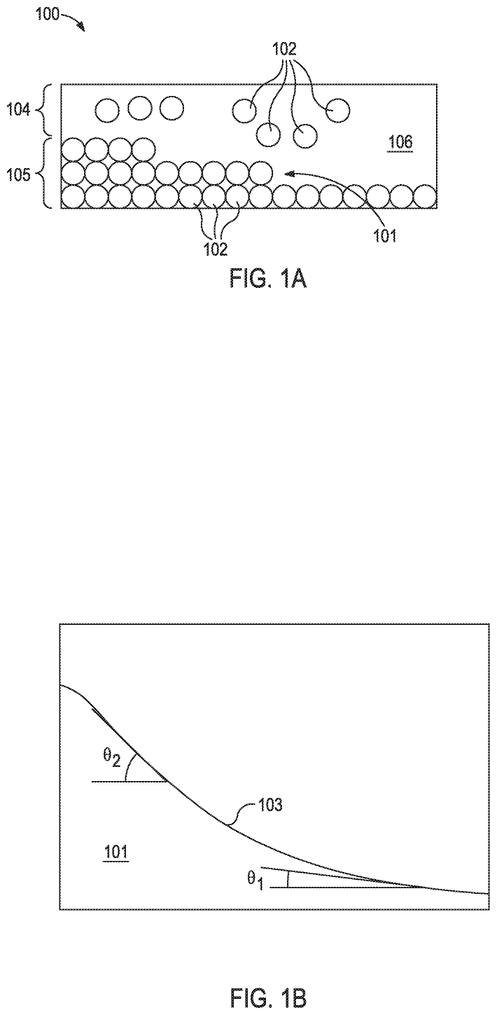

FIG. 1A schematically illustrates a fracture 100 having a proppant bed 101 formed (or deposited) therein. As illustrated, two layers may be defined in the fracture 100, a first or “top” layer 104 including proppant slurry 106 and a second or “bottom” layer 105 including the proppant bed 101, which includes settled proppant 102. The granular solids, bio-degradable materials, and other constituent components that make up the proppant 102 are assumed to be rigid spheres that are suspended in (or carried by) the proppant slurry 106 in the first layer 104. In the second layer 105, the proppant 102 is “settled” on a fracture surface and is not suspended in the proppant slurry 106. The proppant 102 settles on the fracture surface at a maximum packing density.

It should be noted that, although the second layer 105 includes a “settled” proppant bed 101, the proppant 102 in the proppant bed 101 may or may not be stationary. Rather, the proppant 102 in the second layer 105 may transition into the first layer 104 due to external forces, such as the flow of the proppant slurry 106. Similarly, the proppant 102 in the first layer 104 may transition into the second layer 105 due to external forces. Thus, because of the transportation (evolution) of proppant 102 between the first layer 104 and the second layer 105, the height of the proppant bed 101 may vary in time and space. Stated otherwise, the height of the proppant bed 101 at a given location in the fracture may be different at different times, and the proppant bed 101 at different locations in the fracture may be of different heights.

In some of the embodiments disclosed, governing equations for a one-dimensional multiphase fluid flow model in the fracture 100 may comprise one or more fluid flow variables including, but not limited to, slurry mass flow rate (m), slurry pressure (P), proppant volume fraction in the slurry (φ), settled proppant bed area (A_{b}), and the fluid mass flow rate (m_{d}) through the settled proppant bed. However, it will be understood that in other embodiments it may be possible to write governing equations based on one or more other variables (e.g., velocity in place of mass flow rate or mass fraction in place of volume fraction), without departing from the scope of the disclosure.

As disclosed herein, example multiphase fluid flow models describe the development and evolution of the proppant bed 101. In some embodiments, the mass conservation equation for the proppant 102 in the proppant bed 101 may be provided as follows:

(A_{b}φ_{c})ₜ+(u_{b}A_{b}φ_{c})ₓ=S_{BE} (1)

where A_{b} is the effective cross-sectional area of the proppant bed 101, which for a fracture is defined as A_{b}=wh_{b} with w denoting the width of the fracture and h_{b} denoting the height of the proppant bed 101, φ_{c} denotes the critical proppant volume fraction in the proppant bed 101, u_{b} denotes the horizontal velocity of the proppant bed 101 due to friction at the bed-slurry interface, and S_{BE} is a source term that may be used to capture effects of settling and resuspension of the proppant 102. S_{BE} may be defined as

S_{BE}=w(vₛϕ−vᵣϕ_{c}) (2)

where vₛ denotes the settling velocity of the proppant 102, vᵣ denotes the resuspension velocity of the proppant 102, and ϕ is the proppant volume fraction in the proppant slurry 106. Subscripts x and t as used in Equation (1) indicate partial derivatives with respect to those variables throughout the document. It will be understood by one skilled in the art that equation (1) is an example of a mass conservation equation that may be used for some embodiments disclosed herein, and that other suitable mass conservation equations may alternatively be used, without departing from the scope of the disclosure. It will also be understood that although the variables of equation (1) are described in terms of a fracture, equation (1) may be used for any other portion of a well system (e.g., the wellbore itself) and other appropriate geometric information may instead be used. For example, in case of applying Equation (1) to a wellbore, x may represent the axial position along the wellbore, the effective cross-sectional area A_{b} of the proppant bed 101 may be replaced by the cross-sectional area of a proppant bed formed in the wellbore, and so on.

In some embodiments, the settling velocity of the proppant 102 may be defined as:

vₛ=v_{∞}(m̅,ϕ,h_{b})ƒ₁(ϕ)ƒ₂(w) (3)

where v_{∞} denotes the settling velocity of the particle in infinite domain, ƒ₁(ϕ) denotes the effect of multiple particles, and ƒ₂(w) denotes the effect of finite domain size. The functions ƒ₁(ϕ) and ƒ₂(w) can be obtained from validated models for the type of fluid, proppant and domain under consideration.

In some embodiments, the resuspension velocity vᵣ of the proppant 102 may be a function of m̅, which is the scaled mass flow rate of the proppant slurry 106, ϕ is the proppant volume fraction in the proppant slurry 106, and h_{b} denoting the height of the proppant bed 101. The resuspension velocity vᵣ indicates the rate at which the proppant bed 101 is eroded and can be obtained from known validated models.

An angle θ may be defined between a lateral surface of the proppant bed 101 and the base of the proppant bed 101. The value of the angle θ may determine the equilibrium of the proppant bed 101. The proppant bed 101 is considered to be in equilibrium when the value of the angle θ is less than or equal to a critical angle θ_{c}. For a value of the angle θ above the critical angle θ_{c}, the proppant bed 101 may be considered to be unstable and the proppant bed 101 may “settle” to attain equilibrium. Stated otherwise, the base of the proppant bed 101 may move laterally (or horizontally) until the angle θ is less than or equal to the critical angle θ_{c}. The angle θ may have different values at different locations along the lateral surface. Referring briefly to FIG. 1B, illustrated is the proppant bed 101 having a lateral surface 103 that defines angles θ1 and θ2. In some embodiments, the horizontal velocity of the proppant bed 101 may be defined as:

$${u}_{b} = \{ \begin{matrix}β g ( {θ}^{+} {μ}_{s} cos θ - {θ}^{-} {μ}_{s} cos θ - sin θ ) cos θ {f}_{Sm} ( θ ) , & θ > {θ}_{c} \\ 0 , θ \leq {θ}_{c} & \end{matrix} \qquad ( 4 )$$

where θ is the angle (either angle θ1 or θ2) and is given by

$$θ = {tan}^{- 1} ( \frac{\partial {h}_{b}}{\partial x} ) ,$$

μₛ is the coefficient of friction at the interface of the proppant bed and proppant slurry, θ_{c} is the critical angle at or below which the proppant bed 101 is horizontally stable and is given by θ_{c}=tan⁻¹(μₛ), g is the acceleration due to gravity, β is an adjustable parameter that can be used to calibrate the multiphase fluid flow model, and ƒₛₘ(θ) is a smoothing function to ensure a smooth transition from 0 to non-zero values for a more stable numeric behavior. The values θ⁺ and θ⁻ may be based on the angle θ and may be defined as:

$${θ}^{+} = \{ \begin{matrix}1 , 0 \leq θ < \frac{π}{2} \\ 0 , - \frac{π}{2} \leq θ < 0\end{matrix} \\ {θ}^{-} = \{ \begin{matrix}0 , 0 \leq θ < \frac{π}{2} \\ 1 , - \frac{π}{2} \leq θ < 0\end{matrix} \qquad ( 5 )$$

It will be understood by one skilled in the art that other proppant bed velocity equations may be used in place of equation (4), without departing from the scope of the disclosure.

Returning to FIG. 1A, in some embodiments, the mass conservation equation for the proppant slurry 106 may be characterized as follows:

$${( \frac{A ρ + α {A}_{d} {ρ}_{d}}{{ρ}_{0}} )}_{t} + {( \overline{m} + α {\overline{m}}_{d} )}_{x} = {S}_{CE} \qquad ( 6 )$$

where A is the effective cross-sectional area of the fracture 100, ρ is the density of the proppant slurry 106, ρ₀ is a density scale, A_{d} is the flow area of the proppant bed 101, ρ_{d} is the density of the fluid from the proppant slurry in the proppant bed 101, m̅ is the scaled mass flow rate of the proppant slurry 106, and m̅_{d} is the mass flow rate of fluid through the proppant bed 101. S_{CE} is a source term that denotes the mass source in proppant slurry 106 due to proppant 102 moving from proppant slurry 106 to the proppant bed 101, and may be characterized as:

$${S}_{CE} = - ( 1 - α ) \frac{{S}_{BE} ( {ρ}_{P} + {ρ}_{b} \frac{1 - {φ}_{c}}{{φ}_{c}} )}{{ρ}_{0}} \qquad ( 7 )$$

The parameter α has a value depending on whether the analysis considers the fluid flow through the proppant bed 101. The value of the parameter α is 1 when the fluid flow through the proppant bed 101 is considered and 0 otherwise. The flow area A_{d} of the proppant bed 101 may be given by

A_{d}=h_{b}W(1−ϕ_{c}) (8)

where ϕ_{c} is the critical proppant volume fraction.

In some embodiments, the momentum conservation equation for the one-dimensional multiphase fluid flow model may be characterized as follows:

$$( 1 - {f}_{Br} ) ( \frac{{ρ}_{0}}{{P}_{0}} \frac{12 μ \overline{m}}{ρ {w}^{2} A} + {\overline{P}}_{x} ) + {f}_{Br} ( \frac{{ρ}_{0}}{{P}_{0}} \frac{μ \overline{m}}{ρ {k}_{KC} A} + {\overline{P}}_{x} ) = {S}_{ME} \qquad ( 9 )$$

where ƒ_{Br} denotes the blending function, w is the fracture width, P₀ is the proppant slurry 106 pressure scale, μ is the viscosity of the proppant slurry 106, P̅ₓ is the scaled pressure in the fracture, and S_{ME} is a source term. In other embodiments, the fracture width w may be another characteristic length scale related to a portion of a well system (e.g., a wellbore diameter).

k_{KC} is Kozeny-Carman permeability, which is defined as:

$${k}_{KC} = \frac{{{d}_{P}^{2} ( 1 - φ )}^{3}}{{C}_{KC} {τ}^{2} {φ}^{2}} \qquad ( 10 )$$

where d_{P} represents the diameter of the proppant 102, τ is tortuosity, and C_{KC} is the Kozeny-Carman constant. In some embodiments, the Kozeny-Carman constant C_{KC} may account for the specific surface area of a proppant pack and may be determined theoretically or empirically. It will be understood by one skilled in art that equation (9) is an example momentum conservation equation, and other momentum conservation equations may also be suitable for different flow regimes or different blending functions. In other embodiments, equation (9) may be rearranged and written in different forms which may indicate a different blending of the two flow regimes. In some embodiments, the momentum conservation equations may represent both Newtonian and non-Newtonian fluids.

The source term S_{ME} can take a variety of forms depending upon the physical effects to be captured. A simplified form of the source term S_{ME} that captures only the momentum loss due to loss of proppant 102 from proppant slurry 106 to the proppant bed 101 may be given by

$${S}_{ME} = - ( 1 - α ) \frac{{w}^{2} \overline{m} {ρ}_{0}}{12 μρ A} {S}_{BE} ( {ρ}_{P} + {ρ}_{b} \frac{1 - {φ}_{c}}{{φ}_{c}} ) \qquad ( 11 )$$

In some embodiments, the blending function ƒ_{Br} is a function of the proppant volume fraction φ in the proppant slurry 106. The blending function may allow a multiphase fluid flow model to account for the whole range of proppant volume fractions, including zero proppant, low proppant volume fractions, moderate proppant volume fractions, high proppant volume fractions, and the critical proppant volume fraction φ_{c}. In some embodiments, the blending function blends the regimes for various proppant concentrations. Numerical stability of a multiphase fluid flow model may be improved if there is not an abrupt transition between flow regimes. The blending function may be a smooth function of proppant volume fraction to avoid an abrupt transition, which may improve the stability of the numerical solution. In some embodiments, the blending technique may allow a multiphase fluid flow model to properly predict the pressure response in embodiments where proppant slurry flow involves both high and low proppant loading regimes. For example, in some embodiments, the blending function may blend the Reynolds regime (e.g., for low proppant concentrations) and the Darcy regime (e.g., for high proppant concentrations) as shown in equation (9).

In some embodiments, the blending function may be described as:

$${f}_{Br} ( φ ) = \frac{{f}_{Br , max} + {f}_{Br , min} {e}^{s ( {φ}_{Tr} - φ )}}{1 + {e}^{s ( {φ}_{Tr} - φ )}} \qquad ( 12 )$$

where s is a slope, ƒ_{Br,max} is the maximum value for ƒ_{Br}, and ƒ_{Br,min} is the minimum value for ƒ_{Br}. In some embodiments, the blending function of equation (12) may provide a smooth transition from dilute to concentrated slurry flow regimes. It will be understood by one skilled in the art that equation (12) is an example form of a blending function, and that other forms of blending function may be suitable. The slope, maximum value, and minimum value may be built into the model or user-defined. For example, s, ƒ_{Br,max}, and ƒ_{Br,min} may be part of a hydraulic fracturing simulator, or a user of a hydraulic fracturing simulator may be able to input them into a simulator. In some other embodiments, the form of the blending function, the slope, the maximum value, and/or the minimum value are determined based, at least in part, on at least one of the well system, the fluid flow variables, and the desired blend between flow layers, and any combination thereof.

In some embodiments, the one-dimensional multiphase fluid flow model may also include a proppant transport model that defines the conservation of mass of proppant in slurry and which may be described as follows:

(A*ϕ)ₜ+(u_{P}A*ϕ)ₓ=S_{SE} (13)

where u_{P} is proppant transport velocity, A* is the cross-sectional area of the fracture above the proppant bed, and S_{SE} is a source term and is exactly opposite to the source term S_{BE} in equation (1) above, i.e., S_{SE}=−S_{BE}. It will be understood by one skilled in the art that equation (13) is only one example, and that the proppant transport model may comprise other equations as well, without departing from the scope of the disclosure.

In some embodiments, the geometric cross-sectional area of the fracture above the proppant bed 101 may be characterized as follows:

A*=(h_{ƒ}−h_{b})w (14)

where h_{ƒ} is the height of the fracture, h_{b} is the height of the proppant bed 101 in the fracture, and w is the fracture width. Although equation (14) is directed to the cross-sectional area of a fracture, it will be understood by one skilled in the art that other appropriate geometric information may be used to determine the cross-sectional area of other portions of the well system (e.g., the diameter of the wellbore).

The proppant transport velocity u_{P} may satisfy a bridging criterion by providing the necessary drag on the proppant 102 relative to the fluid phase. The bridging criterion may be user-defined or calculated. In some embodiments, the proppant transport velocity u_{P} may account for geometric bridging and/or bridging due to the concentration effect.

In some embodiments, the proppant transport velocity u_{P} may be given as:

$${u}_{P} = \frac{F ( \frac{B {d}_{P}}{w} ) ( 1 - \frac{φ}{{φ}_{c}} ) \overline{m}}{A ( {f}_{B r} {ρ}_{b} + ( 1 - {f}_{Br} ) ( F ( \frac{B {d}_{p}}{w} ) ( 1 - \frac{φ}{{φ}_{c}} ) {ρ}_{P} φ + {ρ}_{b} ( 1 - φ ) ) )} \qquad ( 15 )$$

where F is a geometric function that satisfies a geometric bridging criteria, w is a characteristic length scale for a portion of the well system (e.g., fracture width), ρ_{P} is the density of the proppant 102, ρ_{b} is the density of the fluid forming the proppant slurry 106, and B is a user-defined bridging multiplier. In some embodiments, B may be a geometry condition to account for the geometry of a fracture or other flow path, and may be calculated, determined experimentally, or determined from field observations. In some embodiments, characteristic length scales may comprise any suitable length scale for a portion of a well system, including, but not limited to the width of a fracture, the diameter of a wellbore, and any other suitable well system length scale.

Equation (15) is based on a validated drag model that is applicable for both Newtonian and non-Newtonian fluids. In some embodiments, a multiphase fluid flow model comprising equation (15) may provide realistic bridging behavior for proppant-laden flow. It will be understood by one skilled in the art, however, that other proppant transport velocity equations may be used in place of equation (15).

In some embodiments, the momentum conservation equation that assumes a Darcy flow through the proppant bed 101 may be characterized as:

$${\overline{m}}_{d} = \frac{{ρ}_{d} {P}_{0}}{{ρ}_{0}} \frac{{k}_{KC , d} {A}_{d}}{{μ}_{d}} {\overline{P}}_{x} = 0 \qquad ( 16 )$$

where m̅_{d} is the scaled mass flow rate of fluid through the proppant bed 101, μ_{d} is the viscosity of fluid in the proppant bed 101, and k_{KC,d} is Kozeny-Carman permeability of the proppant bed 101 and is defined as:

$${k}_{KC , d} = \frac{{{d}_{P}^{2} ( 1 - {φ}_{c} )}^{2}}{{C}_{KC} {τ}^{2} {φ}_{c}^{2}} \qquad ( 17 )$$

It will be understood by one skilled in the art that the momentum conservation equation (16) is an example and other momentum conservation equations suitable for the well systems may be used in place of equation (16), without departing from the scope of the disclosure.

In some embodiments, the multiphase fluid flow model may comprise one or more additional models and/or governing equations. Examples of additional models and governing equations are described below, but it will be understood by one skilled in the art that other equations or models may be used, without departing from the scope of the disclosure.

In some embodiments, the one-dimensional multiphase fluid flow model may include a scaling model including one or more of the following equations:

P=P₀P̅ (18)

m=ρ₀m̅ (19)

The scaling parameters (e.g., P₀ and ρ₀) may be chosen to improve the numerical solution of the fluid flow model. For example, the scaling model may improve the conditioning of a linear system arising out of a numerical discretization of the multiphase fluid flow model, which may improve the non-linear convergence behavior of the system.

In some embodiments, the multiphase fluid flow model may comprise one or more permeability models. Equations (10) and (17) are examples of permeability models for packed proppant beds. However, the example multiphase fluid flow model may comprise any other suitable permeability models depending on the application and without departing from the scope of the disclosure.

In some embodiments, the one-dimensional model may comprise area equations, which may be described as an effective area function:

A(ϕ)=A*(1−ƒ_{Br}(ϕ)ϕ) (20)

where A* may be determined according to equation (14). In some embodiments, the function A* may be modified when considering settling and/or resuspension. Due to the presence of fracture width (w), which may depend on fluid pressure and/or rock stress, the area functions may also comprise coupling between a fluid model and a formation model in a hydraulic fracturing simulator. It will be understood by one skilled in the art that other area equations suitable for the well systems may be used in place of equation (20), without departing from the scope of the disclosure.

In some embodiments, the one-dimensional model may comprise a density model, which may be characterized as:

ρ(ϕ)=ƒ_{Br}ρ_{b}+(1−ƒ_{Br})(ρ_{P}ϕ+ρ_{b}(1−ϕ)) (21)
ρ_{d}=ρ_{b}
   where ρ is the density of the proppant slurry 106, ρ_{P} is the density of the proppant 102, and ρ_{b} is the density of the fluid forming the proppant slurry 106, which, in this case is equal to the density ρ_{d} of the fluid in the proppant bed 101. It will be understood by one skilled in the art that other density equations suitable for the well systems may be used in place of equation (21), without departing from the scope of the disclosure.

In some embodiments, the multiphase fluid flow model may comprise a viscosity model, which may be characterized as:

$$μ ( φ ) = {f}_{Br} {μ}_{b} + ( 1 - {f}_{Br} ) {{μ}_{b} ( 1 - \frac{φ}{{φ}_{c}^{μ}} )}^{- 1.8} \\ {μ}_{d} = {μ}_{b} \qquad ( 22 )$$

where μ is the viscosity of the proppant slurry 106, μ_{b} is the viscosity of the fluid forming the proppant slurry 106, and ϕ_{c}^{μ} is the critical proppant volume fraction for the viscosity model. It will be understood by one skilled in the art that other viscosity equations suitable for the well systems may be used in place of equation (17), without departing from the scope of the disclosure.

In some embodiments, the above system of equations may be solved using desired discretization methods such as finite difference, finite volume, finite element methods, and the like and any combination thereof. In other embodiments, discretization methods may comprise “time-marching” or “time-stepping” to advance a solution step-by-step.

In some embodiments, the disclosed embodiments may be utilized in hydraulic fracturing simulators, where the example multiphase fluid flow models may be used to model or predict the transport of proppant through a wellbore and into a discrete fracture network (DFN). In other embodiments, the example multiphase fluid flow models may be used to model the settling of the proppant 102 in the DFN to form the proppant bed 101, the resuspension of the settled proppant 102 into the proppant slurry 106 from the proppant bed 101, and/or the formation and evolution of the proppant bed 101 in the DFN. The example multiphase fluid flow models may also model bridging (and debridging) at various portions of a well system, including but not limited at the perforations or inside a fracture. In yet other embodiments, the example multiphase fluid flow models may be used to capture the pressure response due to tip-screen out, reverse-screen out and diversion (both near wellbore and far field). In some embodiments, the example multiphase fluid flow models may simulate fluid flow and proppant transport and bridging during both the injection and flowback portions of a fracturing simulation. In some other embodiments, the simulated fluid flow obtained using the example multiphase fluid flow models may be used to design a wellbore treatment plan, perform a wellbore treatment operation based on the wellbore treatment plan, and modify the wellbore treatment plan.

Table 1 below provides a comparison of the equilibrium bed heights (h_{b,eq}) as calculated experimentally (Exp.) with the equilibrium bed heights (h_{b,eq}) calculated using the example multiphase fluid flow models disclosed above of different proppant beds formed in a fracture for different proppant slurry compositions. The equilibrium bed heights (h_{b,eq}) have been normalized by the fracture height (h_{ƒ}). In Table 1, ρ_{b} is the density of the fluid used to carry the proppant, μ_{b} is the viscosity of the carrier fluid, d_{P} is the mean proppant diameter, ρ_{P} is the proppant density, Qₛ is the volume flow rate of slurry into the fracture, and ϕ_{P} is the concentration of proppant in the fluid. Table 1 lists the different equilibrium bed heights (h_{b,eq}) for proppant slurry including water, a linear gel G1 (base gel viscosity of 6.5 cP @511 s⁻¹, and power-law parameters n′=0.692, k′=0.038 Pa-sⁿ′) and a liner gel G2 (base gel viscosity of 11 cP @511 s⁻¹, and power-law parameters n′=0.585, k′=0.128 Pa-sⁿ′).

TABLE 1

| Fluid Type + Proppant Type | Case No. | ρ_{b} (kg/m³) | μ_{b} (kg/m-s) | d_{P} (m) | ρ_{P} (kg/m³) | Qₛ (m³/s) | ϕ_{P} (kg/m³) | $\begin{matrix}\frac{{h}_{b , eq}}{{h}_{f}} \\ ( Exp . )\end{matrix}$ | $\begin{matrix}\frac{{h}_{b , eq}}{{h}_{f}} \\ ( Model )\end{matrix}$ |
|---|---|---|---|---|---|---|---|---|---|
| Water + 100 | 1 | 1E3 | 1E−3 | 1.5E−4 | 2650 | 2E−6 | 240 | 0.9285 | 0.930 |
| mesh sand | | | | | | | | | |
| Water + 100 | 2 | 1E3 | 1E−3 | 1.5E−4 | 2650 | 2.67E−6 | 240 | 0.898 | 0.915 |
| mesh sand | | | | | | | | | |
| Water + 100 | 3 | 1E3 | 1E−3 | 1.5E−4 | 2650 | 3.33E−6 | 240 | 0.880 | 0.901 |
| mesh sand | | | | | | | | | |
| Linear gel | 1 | 1E3 | — | 1.5E−4 | 2650 | 1E−6 | 240 | 0.901 | 0.900 |
| G1 + 100 | | | | | | | | | |
| mesh sand | | | | | | | | | |
| Linear gel | 2 | 1E3 | — | 1.5E−4 | 2650 | 2E−6 | 240 | 0.810 | 0.860 |
| G1 + 100 | | | | | | | | | |
| mesh sand | | | | | | | | | |
| Linear gel | 3 | 1E3 | — | 2.97E−4 | 2710 | 2E−6 | 240 | 0.850 | 0.904 |
| G1 + 50 | | | | | | | | | |
| mesh ceramic | | | | | | | | | |
| Linear gel | 4 | 1E3 | — | 1.5E−4 | 2650 | 0.67E−6 | 240 | 0.803 | 0.810 |
| G2 + 100 | | | | | | | | | |
| mesh sand | | | | | | | | | |
| Linear gel | 5 | 1E3 | — | 2.97E−4 | 2710 | 1E−6 | 240 | 0.841 | 0.845 |
| G2 + 50 | | | | | | | | | |
| mesh ceramic | | | | | | | | | |
| Linear gel | 6 | 1E3 | — | 2.97E−4 | 2710 | 2E−6 | 240 | 0.801 | 0.775 |
| G2 + 50 | | | | | | | | | |
| mesh ceramic | | | | | | | | | |

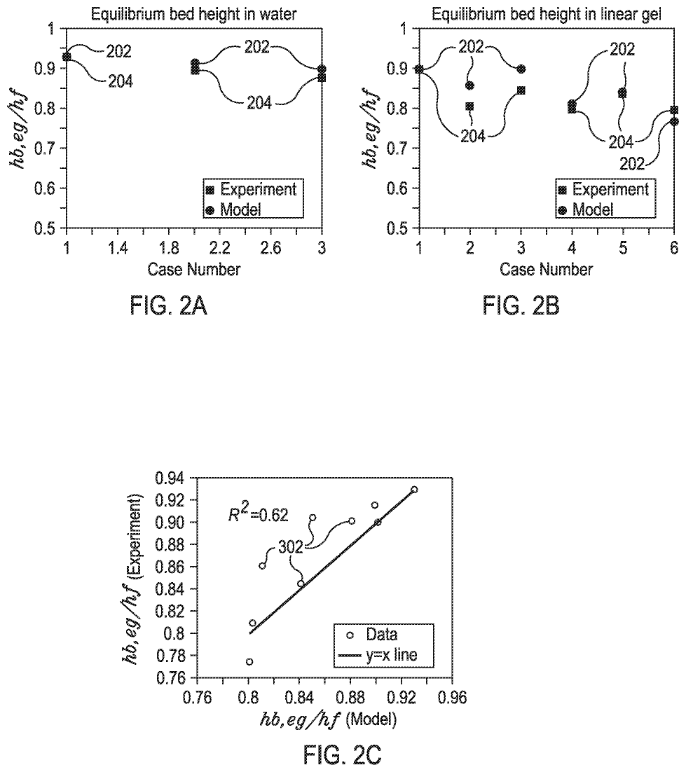

FIGS. 2A and 2B graphically compare the equilibrium bed heights (h_{b,eq}) from Table 1. Specifically, FIG. 2A graphically compares the equilibrium bed heights (h_{b,eq}) due to a water based proppant slurry and FIG. 2B graphically compares the equilibrium bed heights (h_{b,eq}) due to a linear gel G2 based proppant slurry. As seen in FIGS. 2A and 2B, the equilibrium bed heights (h_{b,eq}) calculated using the multiphase fluid flow models (points 202) according to the embodiments disclosed are in close conformation with the equilibrium bed heights (h_{b,eq}) calculated experimentally (points 204).

FIG. 2C illustrates a comparison of the equilibrium bed heights (h_{b,eq}) obtained experimentally and from the example multiphase fluid flow models against a hypothetical “y=x” line that indicates a perfect match between the equilibrium bed heights (h_{b,eq}) (represented by points 302) obtained experimentally and from the example multiphase fluid flow models. Based on the distribution of the points 302, a good fit (R²=0.62) is observed indicating an agreement between the two equilibrium bed heights (h_{b,eq}).

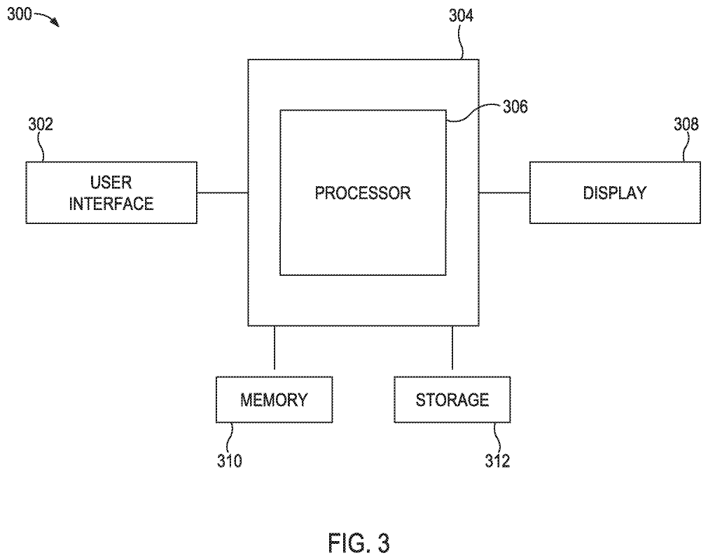

FIG. 3 is a block diagram of a computer system 300 that may be used to construct one or more multiphase fluid flow models and to control stimulation operations performed in a well system according to embodiments disclosed herein. As illustrated, the computer system 300 may comprise a user interface 302, a processor unit 304 having one or more processing components 306, a display 308, a memory 310, and a storage component 312. It should be noted that the illustrated computer system 300 is meant to be representative, and other simulation computer system 300 may include additional components or may operate in the absence of certain illustrated components.

The user interface 302 may be available for an operator or user to input parameters or properties of the well system that is being modeled. Such inputs may include, but are not limited to, fluid flow variables. In addition, the inputs may include information relating to the desired method for modeling and simulating the well system, such as specific discretization schemes to be used or assumptions to be made.

The illustrated processing unit 304 includes a processor 306, which may be designed to receive various inputs from the user interface 302. In addition, the processor 306 may be operably coupled to the memory 310 and the storage component 312 to execute computer-readable instructions for carrying out the example methods disclosed herein and perform other tasks. These computer-readable instructions may be encoded in a computer-readable program code that may be used by the processor 306 to generate the one or more example fluid flow models according to embodiments disclosed and simulate flow of a fluid in a well system. The computer-readable program code may be stored in the memory 310 and the storage component 312. The memory 310 and the storage component 312 include one or more non-transitory, computer-readable storage medium. Examples of a non-transitory computer readable storage medium include random-access memory (RAM) devices, read-only memory (ROM) devices, optical devices (e.g., CDs or DVDs), disk drives, floppy drives, flash memory, solid-state drives, and the like.

The display 308 coupled to the processing unit 304 may be used to visibly display information representative of the simulated fluid flow computed on the processing component 306. In certain embodiments, information representative of the simulated fluid flow may include, but is not limited to fluid velocity, proppant concentration, proppant volume fraction, pressure distribution, a formation stress field, the like, and any combination thereof. In other embodiments, the display 308 may provide other types of information related to the well system. Those of ordinary skill in the art will appreciate that suitable data processing systems may comprise additional, fewer, and/or different components than those described for computer system 300.

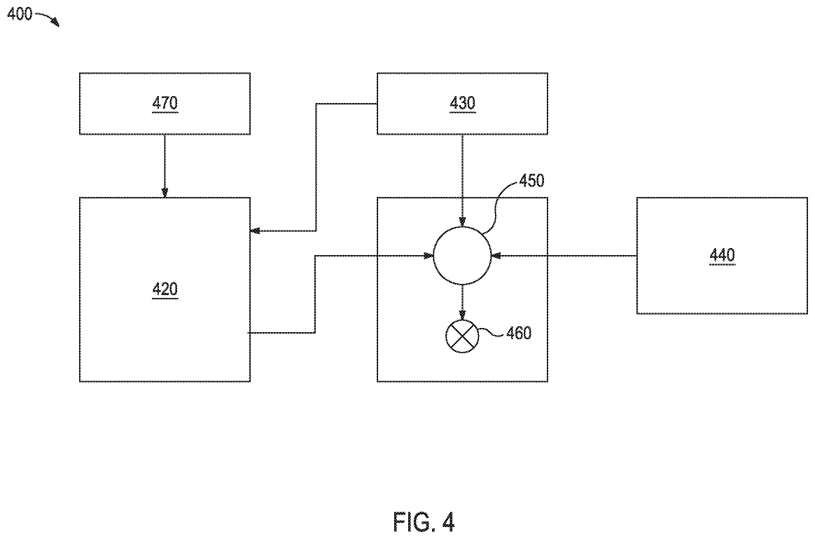

Certain embodiments of the methods disclosed herein may directly or indirectly affect one or more components or pieces of equipment associated with the preparation, delivery, recapture, recycling, reuse, and/or disposal of wellbore compositions. For example, and with reference to FIG. 4, the disclosed methods may directly or indirectly affect one or more components or pieces of equipment associated with a wellbore stimulation system 400, according to one or more embodiments. The wellbore stimulation system 400 includes a fracturing fluid producing apparatus 420, a fluid source 430, a proppant source 440, and a pump and blender system 450 and resides at the surface at a well site where a well 460 is located. As mentioned above, the computer system 300 (FIG. 3) may control the operations of the stimulation system 400. In certain instances, the fracturing fluid producing apparatus 420 combines a pre-cursor with fluid (e.g., liquid or substantially liquid) from fluid source 430, to produce a hydrated fracturing fluid that is used to fracture the formation. The hydrated fracturing fluid may be a fluid for ready use in a fracture stimulation treatment of the well 460 or a concentrate to which additional fluid is added prior to use in a fracture stimulation of the well 460. In other instances, the fracturing fluid producing apparatus 420 may be omitted and the fracturing fluid sourced directly from the fluid source 430.

The proppant source 440 may include a proppant for combination with the fracturing fluid. The stimulation system 400 may also include additive source 470 that provides one or more additives (e.g., gelling agents, weighting agents, friction reducers, buffering agents, and/or other optional additives) to alter the properties of the fracturing fluid. For example, the other additives 470 may be included to reduce pumping friction, to reduce or eliminate the fluid's reaction to the geological formation in which the well 460 is formed, to operate as surfactants, and/or to serve other functions.

The pump and blender system 450 receives the fracturing fluid and combines it with other components, including proppant from the proppant source 440 and/or the one or more additives from the additive source 470. The resulting mixture may be pumped down the well 460 under a pressure sufficient to create or enhance one or more fractures in a subterranean zone, for example, to stimulate production of fluids from the zone. Notably, in certain instances, the fracturing fluid producing apparatus 420, fluid source 430, and/or proppant source 440 may be equipped with one or more metering devices (not shown) to control the flow of fluids, proppants, and/or other compositions to the pumping and blender system 450. Such metering devices may permit the pumping and blender system 450 can source from one, some or all of the different sources at a given time, and may facilitate the preparation of fracturing fluids in accordance with the present disclosure using continuous mixing or “on-the-fly” methods. Thus, for example, the pumping and blender system 450 can provide just fracturing fluid into the well 460 at some times, just proppants at other times, and combinations of those components at yet other times.

Although not specifically illustrated herein, the disclosed methods and systems may also directly or indirectly affect any transport or delivery equipment used to convey wellbore compositions to the system 450 such as, for example, any transport vessels, conduits, pipelines, trucks, tubulars, and/or pipes used to fluidically move compositions from one location to another, any pumps, compressors, or motors used to drive the compositions into motion, any valves or related joints used to regulate the pressure or flow rate of the compositions, and any sensors (e.g., pressure and temperature), gauges, and/or combinations thereof, and the like.

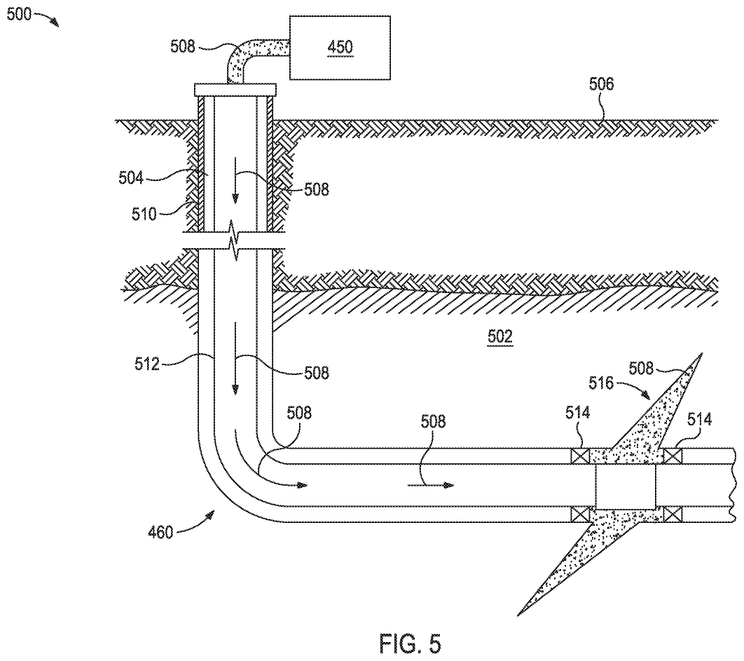

FIG. 5 shows a well system 500 comprising the well 460 of FIG. 4, where the well system 500 is capable of applying the principles of the present disclosure during a fracturing operation. As illustrated, the well system 500 includes a wellbore 504 that penetrates a portion of a subterranean formation of interest 502. The wellbore 504 may extend substantially vertically from the surface 506 and penetrate at least a portion of the subterranean formation 502. At some point, the wellbore 504 may extend substantially horizontally in the subterranean formation 502. As illustrated, the fracturing fluid 508 may be applied to a portion of the subterranean formation 502 surrounding the horizontal portion of the wellbore. Although shown as vertical deviating to horizontal, the wellbore 504 may include horizontal, vertical, slant, curved, and other types of wellbore 504 geometries and orientations, and the fracturing treatment may be applied to a subterranean zone surrounding any portion of the wellbore 504. The wellbore 504 can include a casing 510 that is cemented or otherwise secured to the wellbore wall. The wellbore 504 can be uncased or include uncased sections. Perforations can be formed in the casing 510 to allow fracturing fluids and/or other materials (e.g., a diverter) to flow into the subterranean formation 502. In cased wells, perforations can be formed using shape charges, a perforating gun, hydrajetting and/or other tools.

The well 460 is shown with a work string 512 extending from the surface 506 into the wellbore 504. The pump and blender system 450 of FIG. 4 is coupled to the work string 512 to pump the fracturing fluid 508 into the wellbore 504. The work string 512 may include coiled tubing, jointed pipe, and/or other structures that allow fluid to flow into the wellbore 504. The work string 512 may include flow control devices, bypass valves, ports, and or other tools or well devices that control a flow of fluid from the interior of the work string 512 into the subterranean zone 502. For example, the work string 512 may include ports adjacent the wellbore wall to communicate the fracturing fluid 508 directly into the subterranean formation 502, and/or the work string 512 may include ports that are spaced apart from the wellbore wall to communicate the fracturing fluid 508 into an annulus in the wellbore between the work string 512 and the wellbore wall.

The work string 512 and/or the wellbore 504 may include one or more sets of packers 514 that seal the annulus between the work string 512 and wellbore 504 to define an interval of the wellbore 504 into which the fracturing fluid 508 will be pumped. FIG. 5 shows two packers 514, one defining an uphole boundary of the interval and one defining the downhole end of the interval. When the fracturing fluid 508 is introduced into wellbore 504 (e.g., in the area of the wellbore 504 between packers 514) at a sufficient hydraulic pressure, one or more fractures 516 may be created in the subterranean formation 502. The proppant particulates in the fracturing fluid 508 may enter the fractures 516 as shown, or may plug or seal off fractures 516 to reduce or prevent the flow of additional fluid into those areas.

During or prior to performing the fracturing operation, the flow of the fracturing fluid 508 in one or more fractures 516 and/or the formation and evolution of the bed of settled proppants (from the fracturing fluid 508) due to the flow may be simulated using the example fluid flow models disclosed above. Based on the results of the simulation, a wellbore treatment plan may be designed and/or modified to achieve the desired results. For example, if the simulation results using the fluid flow models indicate a tip-screen out at a certain proppant concentration and fluid viscosity, the treatment plan may be modified to use a lesser proppant concentration, a smaller size proppant, a more viscous (or denser) fluid, or a combination thereof, and the like, to avoid the tip-screen out. As another example, the example fluid flow models may be used to run multiple simulations of different treatment plans in order to select one that most satisfies (or conforms to) user requirements, which may include metrics such as maximum fracture length, maximum proppant penetration, maximum stimulated volume, or a combination thereof, and the like.

Examples disclosed herein include:

A. A method including generating a multiphase fluid flow model defining at least two layers comprising a first layer including a proppant-fluid mixture and a second layer including a bed of settled proppant; simulating a behavior of the bed of settled proppant in a flow path using the multiphase fluid flow model and thereby obtaining a simulation result; and performing a wellbore operation based on the simulation result.

B. A well system including a stimulation system for performing a hydraulic fracturing operation in a wellbore penetrating a subterranean formation; and a computer system including a processor and a non-transitory computer readable storage medium, the computer system being communicatively coupled to the stimulation system and the computer readable storage medium storing a computer readable program code that when executed by the processor causes the computer system to: generate a multiphase fluid flow model defining at least two layers comprising a first layer including a proppant-fluid mixture and a second layer including a bed of settled proppant formed when proppant settles from the proppant-fluid mixture; simulate a behavior of the bed of settled proppant in a flow path using the multiphase fluid flow model and thereby obtain a simulation result; and actuate the stimulation system to perform the hydraulic fracturing operation in the wellbore based on the simulation result.

C. A computer program product tangibly embodied in a computer readable storage medium and comprising a computer readable program code that, when executed by a computer system, causes the computer system to: generate a multiphase fluid flow model defining at least two layers comprising a first layer including a proppant-fluid mixture and a second layer including a bed of settled proppant formed when proppant settles from the proppant-fluid mixture; provide the multiphase fluid flow model with one or more fluid flow variables; simulate a formation and evolution of the bed of settled proppant in a flow path in a wellbore penetrating a subterranean formation using the multiphase fluid flow model and the one or more fluid flow variables, and thereby obtain a simulation result; and actuate a stimulation system for performing a wellbore operation based on the simulation result.

Each of examples A, B, and C may have one or more of the following additional elements in any combination: Element 1: wherein simulating the behavior of the bed of settled proppant comprises: simulating at least one of a movement of the bed of settled proppant in the flow path, a flow of fluid through the bed of settled proppant, a transport of proppant in the proppant-fluid mixture, a transport of the proppant from the bed of settled proppant to the proppant-fluid mixture, a transport of the proppant from the proppant-fluid mixture to the bed of settled proppant, and a combination thereof.

Element 2: wherein the wellbore operation comprises hydraulic fracturing of a subterranean formation, the flow path comprises a fracture network formed in the subterranean formation, and simulating the behavior of the bed of settled proppant comprises simulating the behavior of the bed of settled proppant in the proppant-fluid mixture flowing in the fracture network. Element 3: wherein the flow path includes at least a portion of a wellbore penetrating a subterranean formation and simulating the behavior of the bed of settled proppant comprises simulating the behavior of the bed of settled proppant in the proppant-fluid mixture flowing in the portion of the wellbore. Element 4: further comprising providing the multiphase fluid flow model with one or more fluid flow variables; and simulating the behavior of the bed of settled proppant using the one or more fluid flow variables. Element 5: wherein the one or more fluid flow variables include at least one of a mass flow rate of the proppant-fluid mixture, a pressure of the proppant-fluid mixture, a volume fraction of proppant in the proppant-fluid mixture, a cross-sectional area of the bed of settled proppant, a fluid mass flow rate through the bed of settled proppant, and a cross-sectional area of the flow path. Element 6: wherein generating the multiphase fluid flow model comprises generating a multiphase fluid flow model that takes into account a momentum transfer between proppant and fluid in the proppant-fluid mixture during settling of the proppant to form the bed of settled proppant and resuspension of the proppant from the settled bed of proppant. Element 7: wherein the multiphase fluid flow model is based on at least one of a mass conservation of the proppant in the settled bed of proppant, a mass conservation of the proppant-fluid mixture, a momentum conservation in the proppant-fluid mixture, a mass conservation of the proppant in the proppant-fluid mixture, and a momentum conservation in the settled bed of proppant. Element 8: further comprising: using the simulation result to design a wellbore treatment plan; performing the wellbore operation based on the wellbore treatment plan; and modifying the wellbore treatment plan based on the simulation result.

Element 9: wherein executing the program code further causes the computer system simulate the behavior of the bed of settled proppant by simulating at least one of a movement of the bed of settled proppant in the flow path, a flow of fluid through the bed of settled proppant, a transport of proppant in the proppant-fluid mixture, a transport of the proppant from the bed of settled proppant to the proppant-fluid mixture, a transport of the proppant from the proppant-fluid mixture to the bed of settled proppant, and a combination thereof. Element 10: wherein the flow path comprises a fracture network formed in the subterranean formation and executing the program code further causes the computer system to simulate the behavior of the bed of settled proppant in the proppant-fluid mixture flowing in the fracture network. Element 11: wherein the flow path includes at least a portion of the wellbore and executing the program code further causes the computer system to simulate the behavior of the bed of settled proppant in the proppant-fluid mixture flowing in the portion of the wellbore. Element 12: wherein executing the program code further causes the computer system to: provide the multiphase fluid flow model with one or more fluid flow variables including at least one of a mass flow rate of the proppant-fluid mixture, a pressure of the proppant-fluid mixture, a volume fraction of proppant in the proppant-fluid mixture, a cross-sectional area of the bed of settled proppant, a fluid mass flow rate through the bed of settled proppant, and a cross-sectional area of the flow path; and simulate the behavior of the bed of settled proppant using the one or more fluid flow variables. Element 13: wherein executing the program code further causes the computer system to generate a multiphase fluid flow model that take into account a momentum transfer between proppant and fluid in the proppant-fluid mixture during settling of the proppant while forming the bed of settled proppant and resuspension of the proppant from the settled bed of proppant. Element 14: wherein executing the program code further causes the computer system to generate the multiphase fluid flow model that is based on at least one of a mass conservation of the proppant in the settled bed of proppant, a mass conservation of the proppant-fluid mixture, a momentum conservation in the proppant-fluid mixture, a mass conservation of the proppant in the proppant-fluid mixture, and a momentum conservation in the settled bed of proppant. Element 15: wherein executing the program code further causes the computer system to use the simulation result to design a wellbore treatment plan, perform the hydraulic fracturing operation based on the wellbore treatment plan, and modify the wellbore treatment plan based on the simulation result.

Element 16: wherein executing the program code further causes the computer system to generate a multiphase fluid flow model that takes into account a momentum transfer between proppant and fluid in the proppant-fluid mixture during settling of the proppant while forming the bed of settled proppant and resuspension of the proppant from the settled bed of proppant. Element 17: wherein executing the program code further causes the computer system to use the simulation result to design a wellbore treatment plan, perform the wellbore operation based on the wellbore treatment plan, and modify the wellbore treatment plan based on the simulation result.

By way of non-limiting example, exemplary combinations applicable to A, B, and C include Element 4 with Element 5; Element 6 with Element 7; and Element 13 with Element 14.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method, comprising:
generating a multiphase fluid flow model defining at least two layers comprising a first layer including a proppant-fluid mixture and a second layer including a bed of settled proppant;
simulating a behavior of the bed of settled proppant in a flow path using the multiphase fluid flow model and thereby obtaining a simulation result; and
performing a wellbore operation based on the simulation result.

2. The method of claim 1, wherein simulating the behavior of the bed of settled proppant comprises:
simulating at least one of a movement of the bed of settled proppant in the flow path, a flow of fluid through the bed of settled proppant, a transport of proppant in the proppant-fluid mixture, a transport of the proppant from the bed of settled proppant to the proppant-fluid mixture, a transport of the proppant from the proppant-fluid mixture to the bed of settled proppant, and a combination thereof.

3. The method of claim 1, wherein the wellbore operation comprises hydraulic fracturing of a subterranean formation, the flow path comprises a fracture network formed in the subterranean formation, and simulating the behavior of the bed of settled proppant comprises:
simulating the behavior of the bed of settled proppant in the proppant-fluid mixture flowing in the fracture network.

4. The method of claim 1, wherein the flow path includes at least a portion of a wellbore penetrating a subterranean formation and simulating the behavior of the bed of settled proppant comprises:
simulating the behavior of the bed of settled proppant in the proppant-fluid mixture flowing in the portion of the wellbore.

5. The method of claim 1, further comprising:
providing the multiphase fluid flow model with one or more fluid flow variables; and
simulating the behavior of the bed of settled proppant using the one or more fluid flow variables.

6. The method of claim 5, wherein the one or more fluid flow variables include at least one of a mass flow rate of the proppant-fluid mixture, a pressure of the proppant-fluid mixture, a volume fraction of proppant in the proppant-fluid mixture, a cross-sectional area of the bed of settled proppant, a fluid mass flow rate through the bed of settled proppant, and a cross-sectional area of the flow path.

7. The method of claim 1, wherein generating the multiphase fluid flow model comprises generating a multiphase fluid flow model that takes into account a momentum transfer between proppant and fluid in the proppant-fluid mixture during settling of the proppant to form the bed of settled proppant and resuspension of the proppant from the settled bed of proppant.

8. The method of claim 7, wherein the multiphase fluid flow model is based on at least one of a mass conservation of the proppant in the settled bed of proppant, a mass conservation of the proppant-fluid mixture, a momentum conservation in the proppant-fluid mixture, a mass conservation of the proppant in the proppant-fluid mixture, and a momentum conservation in the settled bed of proppant.

9. The method of claim 1, further comprising:
using the simulation result to design a wellbore treatment plan;
performing the wellbore operation based on the wellbore treatment plan; and
modifying the wellbore treatment plan based on the simulation result.

10. A well system, comprising:
a stimulation system for performing a hydraulic fracturing operation in a wellbore penetrating a subterranean formation; and
a computer system including a processor and a non-transitory computer readable storage medium, the computer system being communicatively coupled to the stimulation system and the computer readable storage medium storing a computer readable program code that when executed by the processor causes the computer system to:
generate a multiphase fluid flow model defining at least two layers comprising a first layer including a proppant-fluid mixture and a second layer including a bed of settled proppant formed when proppant settles from the proppant-fluid mixture;
simulate a behavior of the bed of settled proppant in a flow path using the multiphase fluid flow model and thereby obtain a simulation result; and
actuate the stimulation system to perform the hydraulic fracturing operation in the wellbore based on the simulation result.

11. The well system of claim 10, wherein executing the program code further causes the computer system simulate the behavior of the bed of settled proppant by:
simulating at least one of a movement of the bed of settled proppant in the flow path, a flow of fluid through the bed of settled proppant, a transport of proppant in the proppant-fluid mixture, a transport of the proppant from the bed of settled proppant to the proppant-fluid mixture, a transport of the proppant from the proppant-fluid mixture to the bed of settled proppant, and a combination thereof.

12. The well system of claim 10, wherein the flow path comprises a fracture network formed in the subterranean formation and executing the program code further causes the computer system to simulate the behavior of the bed of settled proppant in the proppant-fluid mixture flowing in the fracture network.

13. The well system of claim 10, wherein the flow path includes at least a portion of the wellbore and executing the program code further causes the computer system to simulate the behavior of the bed of settled proppant in the proppant-fluid mixture flowing in the portion of the wellbore.

14. The well system of claim 10, wherein executing the program code further causes the computer system to:
provide the multiphase fluid flow model with one or more fluid flow variables including at least one of a mass flow rate of the proppant-fluid mixture, a pressure of the proppant-fluid mixture, a volume fraction of proppant in the proppant-fluid mixture, a cross-sectional area of the bed of settled proppant, a fluid mass flow rate through the bed of settled proppant, and a cross-sectional area of the flow path; and
simulate the behavior of the bed of settled proppant using the one or more fluid flow variables.

15. The well system of claim 10, wherein executing the program code further causes the computer system to generate a multiphase fluid flow model that take into account a momentum transfer between proppant and fluid in the proppant-fluid mixture during settling of the proppant while forming the bed of settled proppant and resuspension of the proppant from the settled bed of proppant.

16. The well system of claim 15, wherein executing the program code further causes the computer system to generate the multiphase fluid flow model that is based on at least one of a mass conservation of the proppant in the settled bed of proppant, a mass conservation of the proppant-fluid mixture, a momentum conservation in the proppant-fluid mixture, a mass conservation of the proppant in the proppant-fluid mixture, and a momentum conservation in the settled bed of proppant.

17. The well system of claim 10, wherein executing the program code further causes the computer system to use the simulation result to design a wellbore treatment plan, perform the hydraulic fracturing operation based on the wellbore treatment plan, and modify the wellbore treatment plan based on the simulation result.

18. A computer program product tangibly embodied in a computer readable storage medium and comprising a computer readable program code that, when executed by a computer system, causes the computer system to:
generate a multiphase fluid flow model defining at least two layers comprising a first layer including a proppant-fluid mixture and a second layer including a bed of settled proppant formed when proppant settles from the proppant-fluid mixture;
provide the multiphase fluid flow model with one or more fluid flow variables;
simulate a formation and evolution of the bed of settled proppant in a flow path in a wellbore penetrating a subterranean formation using the multiphase fluid flow model and the one or more fluid flow variables, and thereby obtain a simulation result; and
actuate a stimulation system for performing a wellbore operation based on the simulation result.

19. The computer program product of claim 18, wherein executing the program code further causes the computer system to generate a multiphase fluid flow model that takes into account a momentum transfer between proppant and fluid in the proppant-fluid mixture during settling of the proppant while forming the bed of settled proppant and resuspension of the proppant from the settled bed of proppant.

20. The computer program product of claim 18, wherein executing the program code further causes the computer system to use the simulation result to design a wellbore treatment plan, perform the wellbore operation based on the wellbore treatment plan, and modify the wellbore treatment plan based on the simulation result.
